(19) United States
(12) Patent Application Publication
(10) Pub. No.: US 2006/0216560 A1
(43) Pub. Date: Sep. 28, 2006

(54) Fuel cell systems

(76) Inventors: Stephen David Voller, Hampshire (GB); Richard Michael Clarke, Wokingham (GB)

Correspondence Address: Kenneth I Kohn;Kohn & Associates, Suite 410, 30500 Northwestern Highway, Farmington Hills, MI, 48334, US

(21) Appl. No.: 10/563,070

(22) PCT Filed: Jun. 30, 2004
(86) PCT No.: PCT/GB04/02808

§ 371 Date: Apr. 11, 2006

(30) Foreign Application Priority Data
Jun. 30, 2003 (GB) 0315280.8

(51) Int. Cl. H01M 8/04; H01M 8/06

(52) U.S. Cl. 429/26; 429/34; 429/13; 429/23; 429/19; 429/22

(57) ABSTRACT

A fuel cell system wherein system components are arranged to facilitate the transfer of heat from those components which generate heat in operation to those which cool in operation.

### FIELD OF THE INVENTION

This invention relates, in general, to improvements to fuel cell systems. Fuel cell systems are generally defined as being devices where reactants are fed into one or more fuel cells to produce electrical energy, and certain aspects of the present invention are particularly—but not exclusively—applicable to a particular type of fuel cell system, namely one that employs a so called proton exchange membrane (PEM) fuel cell.

As well known in the art, there is some confusion regarding the use of the term “fuel cell”. In particular, the term is commonly used to refer to an individual cell, as well as to all of the constituent components providing a system that generates electricity from one or more of the aforementioned individual fuel cells. Hereafter the term “fuel cell” will be used to refer to an individual fuel cell, and the term “fuel cell system” will be used to refer to the system as a whole.

### BACKGROUND TO THE INVENTION

In an individual PEM fuel cell, two half-cell reactions take place simultaneously. These reactions comprise an oxidation reaction which occurs at the anode, and a reduction reaction that occurs at the cathode. Together the reactions constitute the total redox (oxidation-reduction) reaction of the fuel cell, namely the formation of water from hydrogen and oxygen.

The anode and cathode of the PEM fuel cell are separated by an electrolyte (typically a solid acid supported within a membrane), and the electrolyte is coated on either side with a suitable catalyst, such as platinum. Typically the anode and cathode will be formed with channels that allow the hydrogen to disperse over the surface of the catalyst. The electrolyte will typically be saturated with an ion transport fluid, such as water, so that hydrogen ions can traverse from the anode through the PEM to the cathode.

FIG. 1 is a schematic perspective view of just such a PEM fuel cell 1, showing the anode 3, PEM 5, cathode 7 and catalyst layers 9. As shown, an electrical circuit is connected between the anode 3 and cathode 7 to channel current for driving a load 11. The electrical circuit does not form part of the fuel cell itself, but has nevertheless been included for illustration.

At the anode, hydrogen molecules come into contact with the catalyst, where they break apart and release electrons in the oxidation part of the aforementioned redox reaction. The released electrons travel around the external electrical circuit to the cathode, and this flow of electrons provides a current for driving the load. Input hydrogen fuel is consumed in the system, and as such the “exhaust” output at the anode side of the cell is normally closed by a valve—that valve only being intermittently opened to disperse any ion transport fluid that may have passed through the semi-permeable PEM and into the aforementioned hydrogen supply channels. For simplicity the cell is depicted in FIG. 1 with an open hydrogen exhaust.

The remaining hydrogen ions at the anode each bond with a water molecule (or equivalent ion transport molecule) to form a hydronium ion (H₃O⁺) which then travels through the PEM to the cathode side of the cell.

At the cathode, oxygen molecules break apart (on contact with the catalyst) and each oxygen atom combines with two electrons (that have travelled through the external circuit from the anode), and two protons (that have travelled through the PEM) to form one molecule of water. Typically, air is used as the fuel rather than pure oxygen.

The redox reaction is exothermic, and as such it is not unusual for the cell to reach temperatures approaching 100 degrees centigrade.

Depending on the materials used, a single fuel cell is typically capable of generating a voltage of something in the order of one volt. As a result, it is commonplace for single fuel cells to be operated in series with a number of like fuel cells (a so-called “stack”) so that the resultant voltages can be summed. Fuel cell stacks are obtainable commercially from suppliers such as Palcan Fuel Cells Ltd of 8658 Commerce Court, Burnaby, British Columbia, Canada V5A 4N6 or Protonics Corp in the US.

The chemical reactions at each of the anode and cathode can be written thus:
At the anode: H₂→2H⁺+2e⁻
At the cathode: ½O₂+2e⁻→H₂O
The overall reaction being: H₂+½O₂→H₂O

FIG. 2 is a schematic view of the core components of a previously proposed fuel cell system, in this example a portable PEM fuel cell system.

As shown, a typical fuel cell system comprises as its core component a so-called fuel cell stack 13 which comprises a number of individual fuel cells 1 (as shown in FIG. 1) connected in series so that the voltages generated are summed.

A source of hydrogen is required, and more recently it has become known to extract hydrogen gas from a metal hydride canister 15. A suitable canister, known as the PC-150 is supplied by Palcan Fuel Cells Ltd. These canisters contain a metal hydride, which releases hydrogen gas when a valve on the canister is opened. Other suitable metal hydride canisters can be obtained from Texaco Ovonic Hydrogen Systems LLC, 2983 Waterview Drive, Rochester Hills, Mich. 48309, USA or Voller Energy Ltd. Whilst it would of course be possible to use pressurised hydrogen gas from a bottle, an advantage of using canisters is that they are very much smaller than a bottle which provides a similar quantity of gas, as well as being much less of an explosive risk.

Interposed between the canister 15 and fuel cell stack 13 are a valve 17 and a regulator 19 which together control the supply of hydrogen fuel to the stack 13. Oxygen (air) is pumped, from atmosphere, into the fuel cell by a pump 21. The advantage of using oxygen from the atmosphere is that it is, in most circumstances, comprised at least partly of water vapour which helps to keep the PEM properly saturated for greater ion flow.

As an alternative to positively pumping air through the stack 13, it is possible to provide only one or more fans which are operable either to blow air over the stack or draw air through it. In this particular arrangement, however, the fans (not shown) are used solely as a means for cooling the stack 13 and for assisting with the dispersal of wet air vented from the cell (via vent 23) on operation thereof.

Electrical energy is output from the stack 13 to a power conditioner 25 that is, in turn, connected to a load 27. Typically the power conditioner 25 is coupled to the load by means of a conventional mains plug/socket arrangement such as the standard UK 3-pin or continental 2-pin arrangement. As the stack 13 generates a direct current, the voltage of which is highly dependent on the load applied, the power conditioner includes a DC-DC converter which is operable to convert the DC output from the stack into a steady DC voltage. The steady DC voltage is then converted to an alternating current by a DC-AC converter to enable the cell to provide a steady alternating current—preferably a standard 240 or 110 V output alternating at 50 Hz.

As shown in FIG. 2, the devices of the fuel cell system are coupled to the power conditioner, from whence they draw their operating power (either before or after it has been conditioned). As the fuel cell system will not produce any current until a flow of oxygen (air) has been established through the cell, a rechargeable power source 29 is provided to power the air pump until the cell is operable to generate sufficient current to drive the pump. The rechargeable power source is continually charged by the output of the cell.

Overseeing proper operation of the cell is a controller 31 which is configured to control the regulator, valve, pump and fans, and other components of the system.

In the implementation of a working fuel cell system, there are a number of potential problems that must be addressed. For example, it is important to ensure that the PEM layers in the stack are properly saturated, as a lack of ion transport material will hamper the extent to which hydrogen ions can migrate from the anode to the cathode, and hence will affect the output of the fuel cell system as a whole. Similarly, an excess of ion transport material (either on the anode or the cathode side of the cell) will impair fuel flow through the cell and thus affect output.

Another point to consider is that in use a metal hydride canister will cool significantly as hydrogen escapes from the hydride, and this cooling causes the rate at which hydrogen escapes to decrease rapidly. As this process continues a canister can rapidly get to a point where it does not provide hydrogen, even though the supply of hydrogen in the canister has not been exhausted.

Conversely, the stack of a typical fuel cell system will rapidly increase in temperature (due to the exothermic nature of the redox reaction), and if unchecked will eventually reach a point where permanent damage can be done to the structure of the individual fuel cells. Fuel cell stacks are notoriously expensive, and as such it is important to try to ensure that they do not overheat. It will also be appreciated that the temperature of the stack will, well before the overheating point is reached, be a contributing factor to the degree of saturation of the PEM layer, and hence the output of the fuel cell system as a whole.

Yet another point of concern is that it is difficult to establish the state of exhaustion of a given hydride canister. This has ramifications for the total amount of fuel wastage in operation of the fuel cell system, and hence the operating cost of the fuel cell system as a whole. The only properties of the canister itself which change as fuel escapes are the magnetic properties of the canister, and these properties are notoriously difficult to measure consistently.

Another problem to be considered when designing such a fuel cell system concerns the manner in which canisters are to be coupled to a pipe which feeds the stack. Typically a male connector will be provided to which a female connector carried by the canister may be attached. A problem with such an arrangement, however, is that the female part of the connector is highly susceptible to damage, and if this should happen then the canister will effectively be unusable. Given that the canisters are relatively expensive this is something that one would want to try and avoid if at all possible.

Yet another factor to consider is the proper management of the various components of a typical fuel cell system. Typical systems have required a relatively high level of user familiarity with the system, and whilst this is no bar for persons familiar with the way in which the components of the system and the system as a whole operate, it is a bar to widespread adoption of such systems by the general public. A user-friendly control mechanism would therefore be an advantage.

One further factor to consider is the proper control of fuel flow through the stack. Hydrogen is potentially a dangerous fuel to be working with, and as such the escape of unused hydrogen should be avoided wherever possible. For example, hydrogen should not be allowed to build up in the stack before air has been pumped into it, not only because such a build up would be dangerous but also because it would be a waste of fuel. In addition, if an electrical load remains connected with the stack on shut down, there is a danger of damagingly low pressures being generated on the anode side of the stack as the hydrogen remaining on the anode side at shut down is progressively consumed.

### OBJECT AND STATEMENT OF INVENTION

It is an object of the present invention to address some or all of the concerns outlined above, and/or provide an alternative to existing fuel cell systems. Embodiments of the invention may provide improvements in the construction of a portable fuel cell system.

Various aspects of the present invention are set out in the accompanying independent claims. Preferred features of each of those aspects are set out in the claims which are dependent thereon, as well as elsewhere in the application. It is to be noted that whilst certain combinations of features herein described have been set out in the accompanying claims, the scope of the present invention extends to any combination or permutation of features described herein irrespective of whether or not that particular combination or permutation has been explicitly specified in the claims.

### BRIEF DESCRIPTION OF THE DRAWINGS

In order that the invention may be well understood, embodiments thereof, which are given by way of example only, will now be described with reference to the drawings, in which:

FIG. 1 is a schematic illustration of an individual fuel cell illustrating its manner of operation;

FIG. 2 is a schematic illustration of the core components of a fuel cell system;

FIG. 3 is a schematic illustration of part of a fuel cell system in accordance with a first aspect of the invention;

FIG. 4 is a schematic illustration of part of a fuel cell system in accordance with a second aspect of the invention;

FIG. 5a is a schematic representation of a fuel cell canister;

FIG. 5b is a schematic representation of a monitoring system;

FIG. 6 is a schematic representation of another monitoring system;

FIG. 7a is a schematic representation of part of a fuel cell system;

FIG. 7b is a detailed schematic representation of part of the system depicted in FIG. 7a; and

FIG. 8 is a schematic representation of a control system for a fuel cell system.

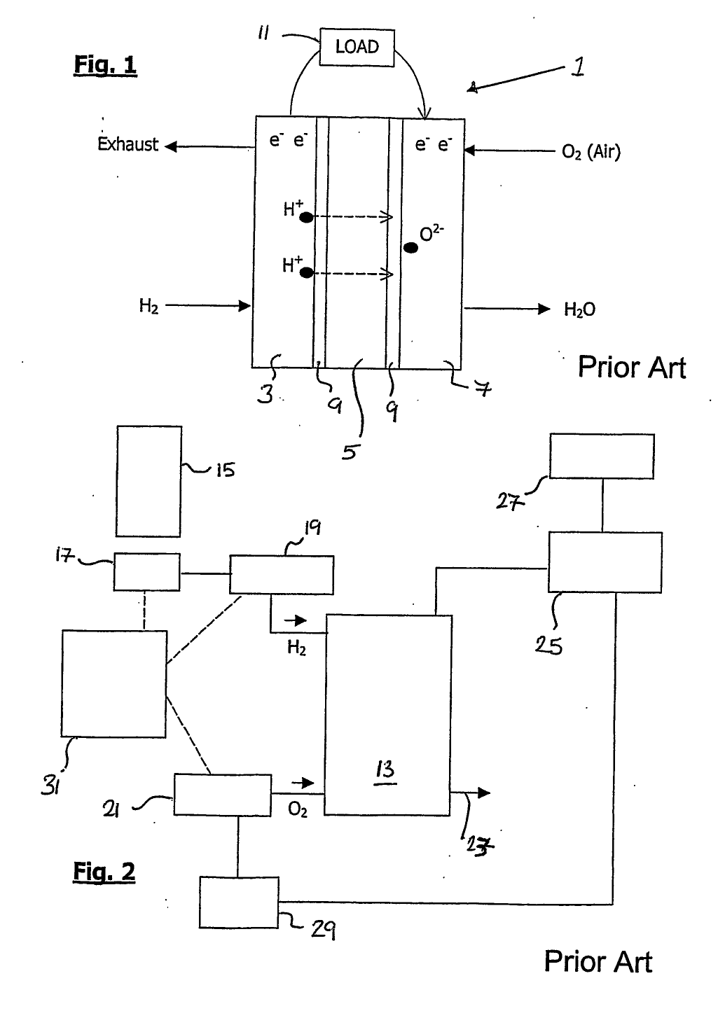

### DETAILED DESCRIPTION

Various aspects of the invention will now be described under the following sub-headings, with particular reference to a PEM fuel cell system. However, this is purely for the purpose of illustration. It will be apparent to those persons skilled in the art that the teachings of these embodiments are applicable to other types of fuel cell systems, and as a consequence the references herein to a PEM fuel cell system should not be construed the use of aspects of the invention with any other type of fuel cell system.

Orientation of Components

As mentioned above, a problem facing the designer of a fuel cell system is that a canister cools markedly as hydrogen escapes from it, and this in turn affects the rate at which hydrogen escapes from the canister. Another problem is that as the redox reaction is exothermic the stack tends to increase in temperature, potentially to the point where it can be permanently damaged. Another factor to consider is that the control electronics, including components such as the aforementioned DC-DC and DC-AC converters, do in themselves get hot and add to the problem of temperature control in the system as a whole.

To alleviate these problems, this aspect of the present invention provides an arrangement of system components which facilitates the transfer of heat from those components which generate heat in operation to those which cool in operation. In a particularly preferred arrangement, the stack and control electronics are arranged so that heat generated is used to warm the hydrogen canister as it cools on release of hydrogen.

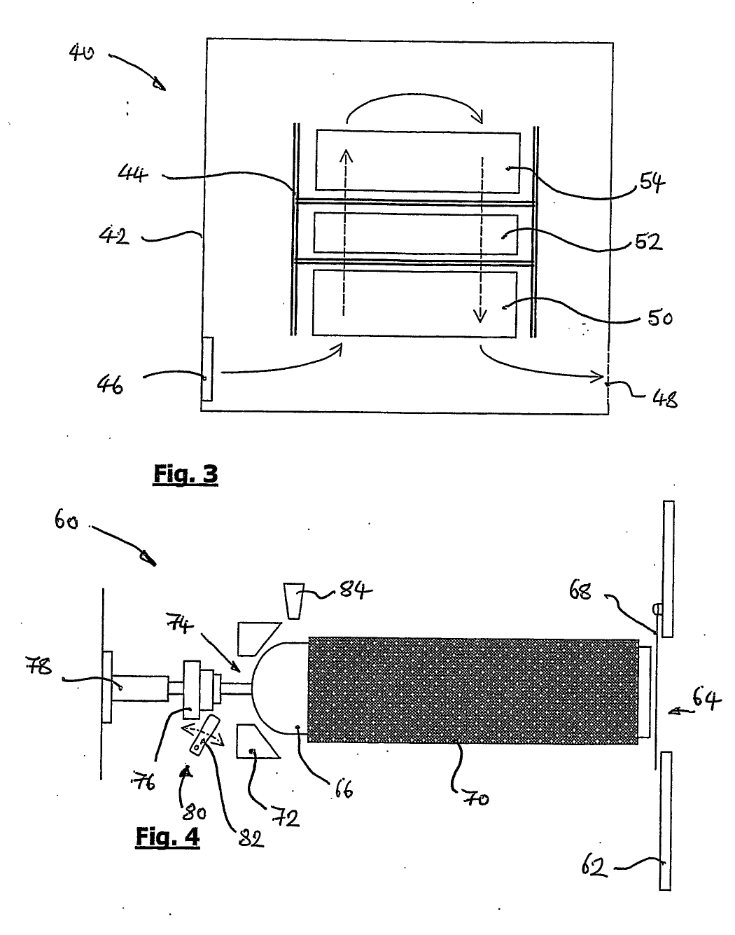

FIG. 3 is a schematic representation of a fuel cell system 40 in accordance with this aspect of the invention. The system comprises a case 42 and an internal frame 44 on which various components of the system are mounted. Air is drawn into the case by means of one or more fans 46, and escapes from the system via one or more vents or grills 48. Further fans may be provided at the vents or grills to draw air and water vapour out of the case 42.

Various system components are mounted on the frame 44, and of those, a stack 50, electronics 52 and metal hydride canister 54 are shown in FIG. 3. Other components are required for proper functioning of the system, but have been omitted from FIG. 3 for clarity.

As previously described, the redox reaction undertaken in the stack 50 in operation of the fuel cell system 40 is exothermic. A consequence of this is that the stack increases in temperature as the system generates electricity. Similarly, components of the electronics 52 (such as, for example, the aforementioned power conditioning devices) will also increase in temperature as the system generates electricity. The metal hydride canister 54, in contrast, cools significantly as hydrogen escapes for use in the stack.

As shown in FIG. 3, in this aspect of the invention the stack 50 and electronics 52 (net heat generators) are mounted underneath the metal hydride canister 54. As the stack and electronics get hotter during system operation, the heat generated rises upwards (as depicted in FIG. 3) where it acts upon the cooling metal hydride canister. Heating the canister in this way helps to counteract the problem of hydrogen escape rate reduction on canister cooling.

The stacked arrangement shown in FIG. 3 may advantageously be reconfigured so that the electronics 52 (or other electrical components) are at the bottom of the stack and the fuel cell stack 50 is between the electronics and the canister 54. In this way, the electronics components are not affected by heat from the fuel cell stack and particularly advantageously, the electronics are spaced apart from the upper regions of the fuel cell system. Hydrogen tends to rise and will naturally collect in the upper regions of the system casing. It is thus advantageous to have the electronics, or electrical components, as far from the upper regions of the casing as possible to reduce the danger of ignition by sparks.

Depending on the amount of heat generated by the stack and electronics, the teachings of this aspect of the invention will at least help to slow the rate at which the hydrogen escape rate reduces. It will be apparent to those skilled in the art that the extent to which this aspect of the invention helps alleviate the aforementioned problem principally depends on the relative sizes of the stack and canister. Thus, a small stack will have less effect on a large canister, whereas a large stack will have a much greater effect on a small canister.

Preferably, the interior of the case 42 is provided with a series of baffles which help to accentuate the chimney effect caused by orientating the components in the manner described. The frame 44 may be provided with ducts and/or cooling fins to assist with heat transfer and/or air flow, as may the abovementioned components, namely the stack, electronics and canister. It is even conceivable that further fans may be mounted in the frame to assist with the flow of air through the system, although care must be taken to ensure that the number of fans provided is not so large as to present a significant electrical drain on the output of the system.

A further advantage associated with this aspect of the invention is that by locating the canister inside the case, the likelihood of the canister being accidentally damaged is significantly reduced.

In an alternative embodiment, the fuel cell stack is water-cooled and the heated cooling water is fed to a heat exchanger. Air is blown over the heat exchanger and the heated air is directed to the hydride canister to heat the canister and thus, at least partially offset the problem of reduction in the hydrogen supply rate that results from cooling of the canister.

The problem of canister cooling primarily affects relatively small canisters. While not so limited, it is believed this aspect of the invention will be most advantageously employed in fuel cell systems designed to receive a canister with a capacity of 500 litres or less.

Canister Docking

Another problem facing the designer of a fuel cell system concerns the manner in which canisters are to be coupled to a pipe which feeds the stack with hydrogen fuel. Such canisters typically carry one part of a male-female (typically the female connector is on the canister) quick-release gas connector which is capable of: (i) avoiding unwanted ingress or egress of gas by automatically closing each half of the connector on disconnection, and (ii) displacing any air void between the two connectors on the connection thereof.

Typically a male connector will be provided in the system to which a female connector carried by the canister may be attached. A problem with such an arrangement, however, is that these connectors are highly susceptible to damage, and if this should happen then the canister will effectively be unusable. Given that the canisters are relatively expensive this is something that one would want to try and avoid if at all possible.

This problem is exacerbated when the canister, as in the aforementioned aspect of the invention, is contained within the case of a fuel cell system as the user will not then be able to see the connector within the housing. In such a situation the chances of the canister being inserted incorrectly or being damaged on insertion are quite significant.

To address this problem, this aspect of the invention provides a fuel cell system that comprises: a connector coupled to a fuel line, and means for guiding a fuel canister into coupling engagement with the connector. Preferably the system also comprises means operable to disengage the canister from the connector.

FIG. 4 is a schematic representation of part of a fuel cell system 60 in accordance with this aspect of the invention.

In this particular example, the components of the fuel cell system are provided within a casing 62, only a part of which is shown. An insertion aperture 64 is formed in the casing 62 to permit fuel canisters 66 (such as the aforementioned metal hydride canisters) to be inserted into and withdrawn from the system. A door 68 is provided, and may be pivoted manually or automatically to open and close the aperture 64. The door helps to prevent warm air from escaping from the casing, and contaminated air from entering the casing.

Immediately inside the casing 62, substantially concentrically mounted with the aforementioned insertion aperture 64, there is provided a cylindrical guide tube 70. The guide tube 70 is arranged to be slightly larger than the canister 66 that is inserted therein, but not so large that the canister will not contact the tube. Contact between the tube and canister is preferred to assist with heat transfer between the tube and canister.

To further assist with heat transfer, the guide tube 70 is perforated so that warm air can pass about the canister. This is particularly advantageous when this aspect of the invention is combined with the teachings of the first aspect of the invention.

A second funnel shaped guide 72 (shown in cross-section) is provided at the inner end of the cylindrical guide tube 70. The funnel guide 72 has a central aperture 74 which is arranged to be slightly larger than a female connector part 76 (carried by the canister 66) of the aforementioned male-female connecter, so that the female connector part can pass therethrough for engagement with a complementary male connector part 78 provided within the casing 62. As illustrated in FIG. 4, the aperture 74 is concentric with the male connector part 78 so as to ensure that the female connector part 76 is properly aligned with the male connector part 78. Preferably, the male-female connector is of the push-fit type. In the illustrated embodiment, the female connector part 76 can be: (a) coupled to the complementary male connector part 78 simply by applying pressure to the canister 66 in a direction generally parallel with the guide tube 70, and (b) decoupled by pushing the female connector part 76 towards the male connector part 78 to uncouple the lock therebetween.

To facilitate the easy removal of the canister 66, in the illustrated, preferred, embodiment there is a disengagement mechanism 80 which is operable to push the female connector part (or a part thereof) towards the male connector part to disengage the male-female coupling. The disengagement mechanism 80 could, for example, comprise a cam 82 which can be rotated against the action of a spring (not shown) to bear upon the female connector part 76. Once the male and female connectors have been uncoupled, the spring is operable to bias the cam to a position where it will not interfere with the female connector part as the canister is withdrawn from the casing 62.

Preferably, a sensor 84 is provided to indicate to a user when a canister has been inserted into the casing 62. Indication to the user may take place, for example, by means of an LED which illuminates when a canister is in place inside the casing. The sensor may comprise any of a number of different types, all of which are well known in the art. For example, the sensor could be an optical sensor, or simply a spring switch which switches from one state to another as the canister moves into and out of abutment therewith.

As an alternative to the perforated tube guide 70, a similar function could be provided by a tube which is longitudinally split into two (or more) separable parts. In such an arrangement, one or both (or more) of these tube parts could be arranged to move towards the other(s) so that a canister is clamped in place in between the various parts of the guide tube. Clamping the canister within the tube will further improve heat transfer between the canister and the tube, and this effect can be accentuated yet further by adding heat transfer fins (or similar structures) to the outside periphery of the tube parts.

As a further alternative, it will of course be appreciated that the teachings of the invention may equally be applied to different types of male-female connectors, for example a male connector part which screws into a female connector part. In such circumstances it may not always be necessary to provide the aforementioned disengagement mechanism.

It will also be appreciated that the teachings of this aspect of the invention as equally as applicable for use in those systems where the connector with which the canister must mate is not provided inside a case or other housing where access is obstructed.

Canister and Monitoring System

As mentioned above, another point of concern is that it is difficult to establish the state of exhaustion of a given hydride canister. This has ramifications for the total amount of fuel wastage in operation of the system, and hence the operating cost of the system as a whole.

This aspect of the present invention seeks to address this problem by providing a canister for use with a fuel cell system, the canister comprising means operable to record data relating to the amount of fuel in a canister; and a fuel cell system comprising means operable to estimate (at least approximately) the quantity of fuel in a canister, and means operable to write to the canister data relating to the estimated quantity of fuel in the canister.

Another facet of this particular aspect of the invention relates to a method for estimating the amount of fuel in a fuel canister of a fuel cell system, the method comprising the steps of: reading data from the canister, said data comprising an indication of the power that may be drawn from a fuel cell system using all the fuel in the canister; monitoring the power consumed by an external appliance when the fuel cell system is in use with that canister; and estimating the amount of fuel remaining in the fuel canister by subtracting the power consumed from the power data read from the canister.

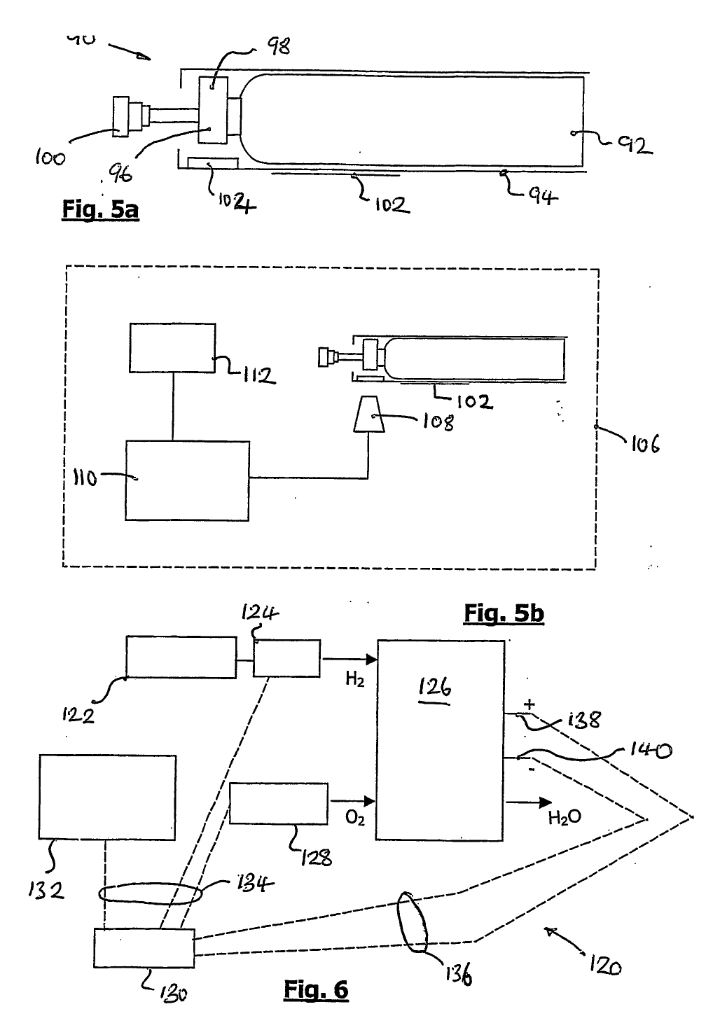

Referring now to FIG. 5a, the canister 90 of this aspect of the invention comprises an inner aluminium, metal, polymer or plastic canister 92 that is inserted inside a low cost replaceable outer sleeve 94. Preferably, the replaceable outer sleeve is manufactured from any of a number of suitable “shock absorbing” materials, so that sensitive gas outlet components of the canister can be protected against damage.

The internal canister 92 is fitted with a safety release valve 96, a thermal release fuse 98 and an approved gas connector 100 (such as the female connector aforementioned). The replaceable sleeve 94 can be printed with information including—but not limited to—company logos, advertising information, safety information, a description of the canister's contents and other items such as a bar code or optically recognised data.

This data may be contained in a magnetic or inductive label 102 affixed to the outside of the sleeve 94—preferably in addition to being recorded in an electronic memory chip or other data storage device 104 affixed securely to the inside or outside of the sleeve.

FIG. 5b illustrates a monitoring system for a fuel cell system 106. As shown, the monitoring system comprises a read/write head 108 which is operable to read and/or write data from or to the data storage device 104 and/or the label 102 and a processor 110.

On insertion of fuel canister 90 into the fuel cell system, the processor 110 is configured to control the read/write head 108 to read, from the data storage device 104, data providing an estimate of the power that may be drawn from a fuel cell system using that canister. The processor 110 is then operable to monitor the amount of power being drawn by an external appliance from the fuel cell system and to estimate the amount of fuel remaining in the canister by subtracting the total power consumed from the data indicating the power that could be drawn from the system using the fuel is remaining in the canister (as read from the data storage device 104).

When the fuel cell system is shut down, or the canister is removed (and optionally at other intervals), the processor is operable to overwrite the power data stored in the data storage device with the estimated power remaining in the canister. In a particularly preferred arrangement, the fuel cell system is arranged to prevent the removal of any given canister (by locking an access door for example) until data has been written to the data storage device 104 by the processor 110 via the read/write head 108.

The processor may be configured to communicate with an output device 112, such as a monitor or an array of LEDs, to provide the user with an indication of the amount of power remaining in any given canister. If a monitor (or optionally an LED display) is provided, other information (such as the age of the canister, the number of times it has been refilled, the identity of canister, and the dates on which it was refilled) may be provided if required by the user.

In the event that the canister is provided without any data stored in the data storage device 104; the processor, on determining that no data is stored, may be configured to control the read/write head 108 to read a product code (in the form of a bar code, for example) or other indicator on the label 102 and retrieve—from a look-up table of product codes and power values—a value for the power available in that particular type of canister.

When individual canisters are refilled, the refilling process would includes the step of updating or reprinting the embedded data. Data relating to, for example, the age of canister, number of refills, identity of canister, refurbishment dates or similar can be recorded.

Fuel Controller

As mentioned above, hydrogen is potentially a dangerous fuel and so the escape of unused hydrogen should be avoided wherever possible. Hydrogen should not be allowed to build up in the stack before air has been pumped into it. This is because such a build up would be dangerous and it would be a waste of fuel.

A further problem, that is particularly apparent on shut-down of the fuel cell system, is that in the event of an electrical load being left connected with the fuel cell stack, any residual hydrogen left in the stack will be consumed because there will be sufficient air circulating on the cathode side of the stack. Because the valving on the anode side of the stack is closed, the consumption of the hydrogen fuel results in low pressures on the anode side that can damage the stack.

An aspect of the invention provides a fuel cell system comprising a fuel cell stack, means for supplying hydrogen fuel to the stack, means for supplying air to the stack, and a controller that is operable—on start-up of the system—to inhibit the supply of hydrogen until air has been supplied to the stack.

Another aspect of the invention provides a fuel cell system comprising a fuel cell stack, means for supplying hydrogen fuel to the stack, means for supplying air to the stack, and a controller that is operable—on shut-down of the system—to inhibit the supply of hydrogen whilst continuing to supply air to the stack to flush residual hydrogen therefrom before subsequently inhibiting the supply of air to the stack.

A further problem facing the designer of a fuel cell system is that as the system builds up to full power output, it is unlikely to produce sufficient energy to power all of the electrical components of the system.

To alleviate this problem there is provided a fuel cell system in which a controller is operable to monitor a voltage produced by a fuel cell stack after start-up, and to selectively inhibit the supply of electrical power to one or more other electrical components of the system until the voltage produced is sufficient to power said one or more components. Preferably, the controller is also operable to selectively inhibit the supply of electrical power to one or more of said components in the event of a drop in the voltage produced by the fuel cell stack.

FIG. 6 is a schematic illustration of components of a fuel cell according to this aspect of the invention.

As shown, the fuel cell system 120 comprises a hydrogen canister 122, a valve 124, a fuel cell stack 126, an air pump 128, and a controller 130. The system includes other electrical components 132 (such as fans, sensors etc.), and details of these components have been omitted from FIG. 6 for clarity.

In use, the valve 124 is operable to permit or deny the passage of hydrogen from the canister 122 into the stack. Similarly, whilst there will probably always be air in the stack, the air pump 128 is operable to drive air through the stack.

The controller 130 includes control lines 134 which are connected to the valve 124, the pump 128, and to the other electrical components 132. The controller also includes stack monitoring lines 136 which are coupled to positive and negative output terminals 138 and 140 of the stack, and which allow the controller to measure the voltage generated by the stack at any time.

On start up, the controller is arranged to power the air pump—from a rechargeable battery or other power storage device (such as a capacitor) to drive air through the stack. Once air has been pumped into the stack, the controller functions to cause the valve 124 to open to allow hydrogen into the stack. As the hydrogen enters the stack, the aforementioned redox reaction starts to occur and a voltage will be generated. The voltage will slowly rise from zero as the stack ramps up to its full output voltage.

Once the stack has passed the initial start-up point and the controller 130 has caused the opening of the hydrogen valve 124, the controller continues to monitor the voltage output by the stack, via monitor lines 136, and as the voltage rises the controller sends signals to the other electrical components 132 to bring them on line. Preferably, the controller brings the other electrical components 132 on line one at a time, and only when there is a voltage being generated that is sufficient to power that component and any other components that have been powered previously.

Throughout operation of the fuel cell system, the controller 130 continues to monitor the voltage output of the stack, and if the voltage output decreases the controller is operable to slow down or shut off the system electrical components. For example, the controller could—in the event of a voltage reduction—slow the speed of any fans provided in the system until the voltage recovers.

In a preferred arrangement where the system electrical components 132 have a number of preset operating speeds and the controller is arranged to slow the system electrical components by increments greater than the increments by which the system components are increased in speed. This aspect of the invention helps alleviate problems associated with components dithering between two adjacent speed settings. In the example of a fan with five operating speeds (zero (minimum), one, two, three, four (maximum)), the controller 130 is arranged to increase the speed of the fans by a single increment—i.e. from “zero” to “one”, from “one” to “two”, from “two” to “three”, and finally from “three” to “four”; and is arranged to slow the fans by two increments—i.e. from “four” to “two”, and from “two” to “zero”.

Preferably, the controller is operable to decouple any external load from the power supply until the power generated by the stack recovers.

Water and Air Management

As mentioned above, it is important to ensure that the PEM layers in the stack are properly saturated, as a lack of ion transport material will hamper the extent to which hydrogen ions can migrate from the anode to the cathode, and hence will affect the output of the fuel cell system as a whole. Similarly, an excess of ion transport material (either on the anode or the cathode side of the cell) can impair fuel flow through the cell and thus affect the system output. Another point to consider is that it is important to dispose of any excess water properly, as that excess water may be a hazard to electrical circuits within the fuel cell system, or indeed to persons using the system.

To alleviate some of these problems, an aspect of the invention provides a fuel cell system comprising a fuel cell stack, means for mixing to a variable extent oxygen depleted air output from the stack with air having a greater oxygen content to provide an air mix for input as fuel to the stack, and means for supplying said air mix to the stack. Preferably the fuel cell system further comprises means for measuring the humidity of said air mix. Preferably, the system further comprises means for automatically varying the ratio of oxygen depleted air to air of greater oxygen content in accordance with said measured humidity.

Another aspect of the invention provides a fuel cell system comprising a fuel cell stack, means for extracting water from a stream of relatively water-rich oxygen-depleted air output from the stack, and means for facilitating the removal of said extracted water. Preferably, the facilitating means is operable to route said extracted water to one or more relatively hot components of the system for evaporation. In another arrangement, the facilitating means is operable to route said extracted water to one or more fans.

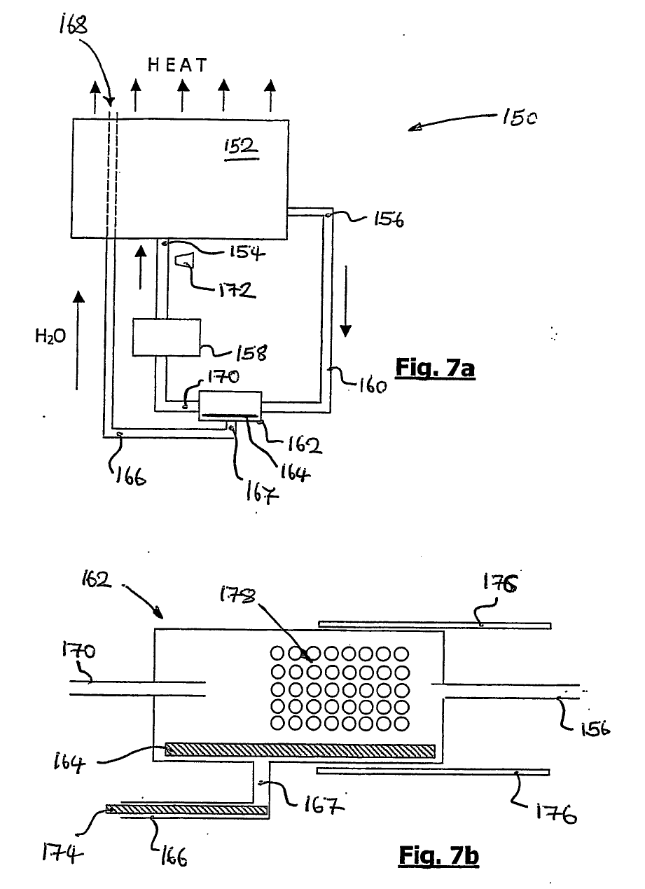

FIG. 7a is a schematic illustration of system components of this aspect of the invention. Other system components which are inessential to the performance of this aspect of the invention have been omitted for clarity.

As shown, a fuel cell system 150 comprises a fuel cell stack 152, into which hydrogen and oxygen (air) are fed in use. The hydrogen input point has been omitted from FIG. 7a for clarity. Air is fed into the stack 152 via inlet 154, and exhaust (i.e. oxygen-depleted) air is output via exhaust 156 along with water generated by the aforementioned redox reaction. Due to the operating temperature of the stack, the water generated by the redox reaction will normally be produced as water vapour. A pump 158 is provided to drive air into the stack 152 via the air inlet 154.

Exhaust air and water vapour is fed from the exhaust 156 via feed line 160 to an expansion chamber 162, where the exhaust vapour is allowed to expand and so cool. As the exhaust vapour cools, so at least some of the water vapour condenses and falls, as water, to a lowermost part of the expansion chamber, which is preferably lined with a water retentive material 164.

A water outlet 167 is located below the water retentive liner 164. The water outlet 167 is connected to a pipe 166 containing a wicking material 174 (FIG. 7b). The arrangement is such that excess water from the liner 164 is fed (for example by gravity) to the wicking material in the pipe 166. The wicking material will draw the excess water to a free end 168 of the pipe 166 which is located, in this embodiment, in close proximity to the stack 152. The heat generated by the stack promotes the evaporation of excess water transported by the wicking material from the expansion chamber 162 for subsequent expulsion from the system 150 by one or more fans which assist with air flow through the system. An ancillary advantage of this arrangement is that the evaporation of the water assists with the cooling of the stack.

As an alternative to the use of heat to promote evaporation, the wicked water could instead (or indeed additionally) be directed into the air flow through the system, for example in the vicinity of one or more of the aforementioned fans.

As shown in FIG. 7a, an outlet 170 of the expansion chamber 162 is coupled to the air pump 158. As will later be explained in detail, fresh air (i.e. air that has not yet been through the stack, and which is therefore not oxygen depleted) can be mixed with air entering the expansion chamber from the exhaust 156 to be pumped into the stack 152 by the air pump 158. The ratio of fresh air to exhaust air in the air mix for pumped into the stack can be varied. In the preferred embodiment, a device for detecting the moisture content of the input air, for example, hygrometer 172, is provided to measure the humidity of the air mix input to the stack.

A controller (not shown) is coupled to the hygrometer 172, and is operable on detection of a reduction in the humidity of the input air to increase the proportion of exhaust air in the air mix fed into the stack by the pump. As the exhaust air is laden with water vapour, so a greater proportion of exhaust air in the input air mix will assist with increasing the amount of water in the stack. Similarly, if the hygrometer 172 should detect an increase in the humidity of the input air mix, the controller can lower the proportion of exhaust air in the input mix. Preferably, variation of the proportion of exhaust air in the air mix is accomplished automatically. It will be apparent, however, that the controller could simply be connected with a means for alerting the user to the fact that the humidity of the input air needs changing, and leave it up to the user to change the humidity of the input air. The controller could, for example, be connected to a suitable device, or devices, for providing an audible and/or visible indication that the humidity of the input air needs to be adjusted.

Preferably, the controller would be able to cause the humidity of the input air mix to be maintained at a predetermined, preferably user adjustable level. For this purpose, the controller may provide signals to a suitable valving device, or devices.

As an alternative, the hygrometer could be dispensed with, and the controller instead arranged to monitor the output voltage of the fuel cell system 150. The controller may then infer, on a reduction of the output voltage, either that the PEM layer is becoming less saturated (thereby inhibiting ion transfer) or is becoming over saturated (thereby allowing ion transport fluid to obstruct the fuel pathways in the stack) and cause the content of the input air mix to be adjusted until the system output rises. In such an arrangement, the controller would be configured to wait for a predetermined period of time after any given adjustment to see whether the output has increased, before making any further adjustments.

In another arrangement, the controller could be configured to monitor both the hygrometer and the output voltage. In such an arrangement the controller would be arranged to record the humidity at which the output voltage is at a maximum and configured to cause adjustment of the input air mix to maintain the humidity at the recorded value at which the output voltage should be a maximum. If the output voltage at the recorded humidity should drop by a predetermined extent, then the controller would seek to identify and record a new humidity value at which the output voltage is a maximum, and subsequently seek to maintain the humidity of input air mix at the new value.

The water retentive material 164 could advantageously be a material such as zeolite which is capable of retaining moisture for relatively long periods of time. An advantage of such a material is that the retained moisture can serve to humidify fresh air which is of relatively low humidity.

FIG. 7b is a schematic view of the expansion chamber 162. As shown, the chamber is coupled to the stack exhaust 156, outlet 170 and pipe 166. The floor of the chamber 162 is lined with a water retentive medium 164, and an output 167 feeds excess water to the wicking material 174 that extends through the pipe 166 to the free end 168 thereof.

The expansion chamber 162 is formed with a plurality of perforations 178 which can be selectively opened to or closed by means of a cowl 176, which can be slid, manually or automatically, over part of the periphery of the expansion chamber 162. Movement of the cowl will increase or decrease the number of perforations which are open to the ambient air, and as such provides a simple means for varying the amount of ambient air available for input as the aforementioned air mix into the stack. A similar effect may be provided by moving the end of the outlet 170 further into or out of the expansion chamber 162.

Many different systems for moving the cowl 176 will be apparent to those skilled in the art. As an example, however, the cowl could be arranged to be moved back and forth by a worm drive.

Control System

As mentioned above, another factor to consider when designing a fuel cell system is the proper management of the various components of the system. Typical known fuel cell systems have required a relatively high level of user familiarity with the system, and whilst this is no bar for persons familiar with the way in which the components of the system and the system as a whole operate, it could be a bar to widespread adoption of such systems by the general public. A user-friendly control mechanism would therefore be an advantage.

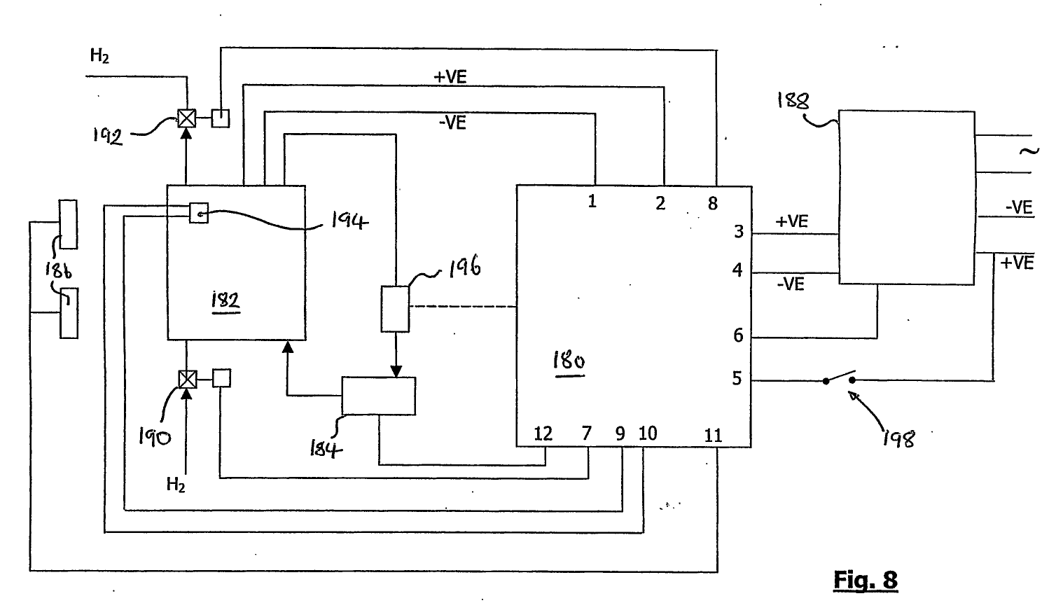

FIG. 8 is a schematic representation of a control system in accordance with an embodiment of this aspect of the invention. As shown, the control system comprises, as its principal component, a controller 180—preferably a microcontroller. In this example, twelve pins of the controller are connected to various components in the system. The identity and function of those pins are summarised in Table 1 below. Preferably, the controller functions can be set by means of a simple user interface controlled over a serial port (not shown). Setting of the controller functions can be accomplished locally, for example with an appropriate serial comms package, or alternatively may be accomplished remotely, over an internet for example.

The fuel cell system of FIG. 8 comprises a stack 182, an air pump 184, fans 186, a power conditioner 188 (comprising both a mains inverter and a DC-DC converter, as previously described). Also provided are a hydrogen inlet valve 190, and a hydrogen outlet valve 192. A thermistor 194, or other temperature sensor, is mounted on or in close proximity to the stack 182. A hygrometer 196 may be provided, in accordance with the aspect of the invention described above, in which case, it is connected to a further pin of the controller (not shown).

The power conditioner 188 is operable to provide an AC voltage or a DC voltage as required. Advantageously, the system includes a switch 198 which, when closed, allows the system to operate in an “automatic” mode that will later be described.

As mentioned above, for proper operation of the system it is necessary to pump air through the stack 182 using the pump 184. The air supplies oxygen to the individual fuel cells of the stack and carries away water produced in the redox reaction to ensure that the cells are not coated in water. If too much air is pumped through the stack, the ion transport medium of the PEM can dry out, adversely affecting the rate of ion transportation and hence the output voltage. The water produced and the airflow rate to control it is proportional to the current or power produced.

To avoid unwanted water build up or inadvertent drying of the PEM cells, the controller 180 is configured to monitor the stack output current (via output voltage monitor lines 1 and 2), and vary the pump speed. In general, the pump speed is increased if a build up of water is determined to have occurred and the pump speed is reduced if a loss of ion transport medium is determined to have occurred.

The speed of the pump can be varied linearly, or alternatively a three (or more) step digital variation may be provided. As explained above, it is preferred that there is a built-in hysterisis whereby the pump steps down one amp lower than the step up. The purpose of this hysterisis, again as explained above, is to stop the pump oscillating between steps. Control of the pump is accomplished via control line connected to pin 12. The three steps for the fans (i.e. the voltages for the speeds) can be set on-board, and the cut in voltages can be set in software.

As mentioned above, in the preferred arrangement the fans come on in up to three steps. These three steps are triggered at stack temperatures set by software and sensed by means of the thermistor 194, which is connected by respective control lines to pins 9 and 10. To protect the stack 182, which is the most expensive component of the fuel cell system, when the temperature sensor (in this embodiment the thermistor 194) senses a predetermined “high” temperature, the fans come on full speed and the inverter or (user load) is cut.

The hydrogen gas is supplied at 3 to 5 psig via a pressure regulator (not shown). The regulator is fed directly from the system gas connector, through a normally closed solenoid valve 190 with a manual override. This is normally over ridden except when Automatic mode is selected.

A hydride canister is normally fitted into the system gas connector. Should the user wish to run the system from bottled hydrogen (as opposed to a metal hydride canister) a proprietary adapter is supplied. This proprietary adapter comprises a tube with a female connecter on the end, and is configured to plug into the system male connector and be released in the normal way (as aforementioned). The base of the tube includes a disc which emulates the base of a normal metal hydride canister. In this base is another female connecter that effectively causes the system connector to be moved to the outside of the case. In the preferred arrangement, the adapter is configured to look, to the aforementioned sensor, like a conventional metal hydride canister.

As aforementioned, the hydrogen is consumed in use but because the membranes are semi permeable some water will collect on the hydrogen side of the individual fuel cells. This water is removed by flushing the hydrogen through the system. In the preferred arrangement, the controller is configured to open, via a control line 8, connected to a normally closed solenoid valve 192 that usually seals the hydrogen end of the stack. In the preferred arrangement, the valve 192 is opened for about 500 ms every 30 seconds. The opening time, and the time between openings, can be adjusted in software and the controller 180 can be configured to vary the opening time and opening frequency in response to the voltage detected on the lines connected to pins 1 and 2.

In the preferred arrangement, any hydrogen vented from the stacked is burnt off in a zirconium tube containing a catalyst, or equivalent. The hydrogen burning produces heat, which is used in turn to heat the canister by introducing it into the cooling air stream.

As mentioned above, the power conditioner 188 comprises both a 230 V or 110 V AC mains inverter, as well as a 13.8 V DC converter. Providing two alternative outputs helps to increase the number of applications that the unit can be applied to and to reduce the number of connector options. Advantageously, 13.8 V DC is the standard charging voltage used in automobiles, and as such will be compatible with any “car cigar lighter” powered chargers or equipment. The unit can also charge directly any 12 volt battery.

To automatically charge batteries or make other automated supplies of power the system controller 180 includes a voltage sensor line connected to pin 5. To use the unit in automatic mode the normally closed solenoid 190 is not overridden and a switch 198 is closed to connect the sensor line 5 to the positive DC output.

When the DC terminals are connected to an external voltage (such as a car battery for example) and the external voltage falls to a predetermined level settable in the software, the external supply opens the normally closed valve 190, and the system starts. The system then proceeds to charge the external voltage, and when the external voltage has been brought up to a predefined level the system switches off. By carefully selecting the cut-in and cut-out voltages, it is possible to maintain the efficiency of the system by only partially charging a lead acid battery, for example.

As mentioned above, it is important that the efficiency of the system is not compromised. Advantageously, the control electronics can be powered from the 13.8V DC voltage from the DC to DC Converter (although the current from the stack has to routed through the control electronics for monitoring). This is because with normal DC regulators the Voltage input is reduced and the difference is released as heat. i.e. on a low load the stack voltage will be say 25 volts and the air pump running at 12 volts and taking 4 watts will waste another 4 watts in the regulator. By using the Switching Converter voltage most of this is saved as the converters are very efficient.

TABLE 1

| Pin | Input/output | Name | Function |
|---|---|---|---|
| 1 | 0 VDC | Ground in | Main ground from stack output |
| 2 | 12 to 27 V | DC in | Main supply from stack output. |
| | DC | | |
| | 13 A max | | |
| 3 | 12 to 27 V | DC out | Main supply to inverter. Monitor for |
| | DC to | | start up voltage and maintain (6) @ |
| | inverter | | 12 V DC when over 12 V DC |
| 4 | 0 V DC | Ground out | Main ground to inverter |
| 5 | 12 V DC in | Charge | Auto charge mode (Inverter initially |
| | | sense | Off). Monitor for Voltage. Maintain |
| | | | (7) at 12 V DC whilst over 11.8 V DC |
| | | | Allow about 30 seconds for damping. |
| 6 | 12 V DC/ma | Inv on | Switch line to inverter/converter See |
| | | | (3) above & (9) |
| 7 | 12 V DC | Auto gas on | Switch on gas valve in Auto mode |
| | 1 amp max | | when (5) is lower than 11.8 V DC. |
| | | | AND external switch set. |
| | | | Current valve: switch 7 W max, 5 W |
| | | | quiescent. |
| 8 | 12 V DC | Stack vent | Normally off, 1 second pulse every 30 |
| | 1 amp max | | seconds whilst (3) is above 12 V DC. |
| | | | No pulse on start up. |
| | | | Current valve: switch 7 W max, 5 W |
| | | | quiescent. |
| 9 | Thermistor + | Temp + | Temp sensor. Lower (6) if more than |
| | | | 70 deg C. Set (11 to 10 V DC @ 50 C. |
| | | | & 12 V DC @ 60 C. |
| 10 | Thermistor − | Temp − | Use if independent ground required |
| 11 | 12 V DC | Fan + | Fan speed control. Normally off. |
| | nom | | Half speed when (9) = 50 C: full speed |
| | | | @60 C. |
| 12 | 12 Vdc | Air pump + | Low speed normal operation. Monitor |
| | | | inverter current (3). Increase to half |
| | | | speed @3 A, then full speed above 6 A. |

In an alternative embodiment, the power conditioner comprises a mains inverter and more than one DC to DC converter. The mains inverter does not take regulated current from a DC to DC converter as previously described, but instead receives voltage from the fuel cell stack and regulates it at its front end. The mains inverter may supply V ac at 50 or 60 Hz.

A first of the DC to DC converters is a main converter and can be used to supply a current limited 13.8 V dc for battery charging or an outlet of the type used for charging cigarette lighters in automobiles. Additional independent DC to DC converters are provided to reduce the power that would be lost through linear devices for driving system components such as pumps and solenoids. By fitting these independently, the system could still work on the AC side if the main DC to DC converter failed.

Pulse width modulation may be used to drive the system pump(s) with greater efficiency.

As mentioned above, various aspects of the invention have been described herein by way of example. It will be understood, however, that modifications may be made to the particular embodiment(s) disclosed without departing from the spirit and scope of the invention.

1. A fuel cell system wherein system components are arranged to facilitate the transfer of heat from those components which generate heat in operation to those which cool in operation.

2. A system according to claim 1, comprising a fuel cell stack, control electronics and a hydrogen canister, the stack and/or control electronics being arranged so that heat generated in use is capable of warming the hydrogen canister as it cools on release of hydrogen.

3. A system according to claim 1, comprising a fuel cell stack and a mounting for a fuel canister, said mounting being arranged such that, in use, heat from the fuel cell stack is transferred to a said fuel canister mounted to said mounting.

4. A system according to claim 3, further comprising a casing and a mounting for said fuel stack, said mounting for a fuel canister being disposed above said mounting for said fuel stack in said casing whereby, in use, heat from said fuel stack rises to heat a said fuel canister mounted in the casing.

5. A system according to claim 4, wherein said mountings include a frame, said frame carrying electrical components of said system and the arrangement being such that, in use, heat from said fuel cell stack and electrical components rises to heat a said fuel canister mounted in the casing.

6. A system according to claim 4 or 5, further comprising at least one air flow directing element in said casing arranged such that, in use, said heat rises by heating air surrounding said fuel cell stack which heat air is directed towards a said fuel canister mounted in the casing by said at least one air flow directing element.

7. A fuel cell system comprising a portable casing, a fuel cell stack mounted in said casing, a mounting for a fuel canister in said casing and a mounting for electrical components in said casing, the arrangement being arranged such that said fuel cell, electrical components and a fuel canister mounted to said fuel canister mounting are in stacked relationship, whereby, in use, heat from said electrical components and fuel stack can rise to heat said fuel canister.

8. A fuel cell system comprising a connector coupled to a fuel line, and means for guiding a fuel canister into coupling engagement with the connector.

9. A system according to claim 8, comprising means operable to disengage the canister from the connector.

10. A fuel cell system comprising a fuel supply line connected with a fuel cell stack having a connector at an end thereof for connecting with a connector of a fuel canister and a guide arrangement for guiding a said fuel canister to a mounted position at which said connector of the fuel canister connector connects with said connector of the fuel supply line.

11. A system according to claim 10, wherein said connectors are push-fit connectors that permit release of a connection therebetween by movement of the connector of the fuel canister toward the connector of the fuel supply line, the system further comprising a device for moving said connector of the fuel canister toward the connector of the fuel supply line.

12. A system according to claim 11, wherein said device comprises a rotatable cam member.

13. A fuel canister for use with a fuel cell system, the canister comprising means operable to record data relating to the amount of fuel in the canister.

14. A fuel cell system for use with the canister of claim 5, the system comprising means operable to estimate (at least approximately) the quantity of fuel in a canister, and means operable to write to the canister data pertaining to the estimated quantity of fuel in the canister.

15. A method for estimating the amount of fuel in a fuel canister of a fuel cell system, the method comprising the steps of: reading data from the canister, said data comprising an indication of the power that may be drawn from a fuel cell system using all the fuel in the canister; monitoring the power consumed by an external appliance when the fuel cell system is in use with that canister; and estimating the amount of fuel remaining in the fuel canister by subtracting the power consumed from the power data read from the canister.

16. A fuel cell system comprising a controller and a data reader, said data reader being operable to read data from a data storage element carried by a fuel canister connected with the system and said controller being operable to monitor power output from the system and determine an indication of the amount of fuel in said fuel canister based on the data read from said storage element and said power output.

17. A system according to claim 16, wherein said data reader is a read/write device and is operable to write data to said storage element to modify the data stored on said storage element.

18. A fuel cell system comprising a fuel cell stack, a hydrogen supply source for supplying hydrogen fuel to the stack, an arrangement for supplying air to the stack, and a controller that is operable—on start-up of the system—to inhibit the supply of hydrogen until air has been supplied to the stack.

19. A fuel cell system comprising a fuel cell stack, a hydrogen supply source for supplying hydrogen fuel to the stack, an arrangement for supplying air to the stack, and a controller that is operable—on shut-down of the system—to inhibit the supply of hydrogen whilst continuing to supply air to the stack to flush residual hydrogen therefrom before subsequently inhibiting the supply of air to the stack.

20. A fuel cell system in which a controller is operable to monitor a voltage produced by a fuel cell stack after start-up, and to selectively inhibit the supply of electrical power to one or more other electrical components of the system until the voltage produced is sufficient to power said one or more components.

21. A system according to claim 20, wherein the controller is also operable to selectively inhibit the supply of electrical power to one or more of said components in the event of a drop in the voltage produced by the fuel cell stack.

22. A fuel cell system comprising a fuel cell stack, means for mixing to a variable extent oxygen-depleted air output from the stack with air having a greater oxygen content to provide an air mix for input as fuel to the stack, and means for supplying said air mix to the stack.

23. A system according to claim 22, comprising means for measuring the humidity of said air mix.

24. A system according to claim 23, comprising means for automatically varying the ratio of oxygen-depleted air to air of greater oxygen content in said air mix in accordance with said measured humidity.

25. A system according to claim 22, comprising means operable to monitor the voltage output of the fuel cell stack.

26. A system according to claim 25, comprising means for automatically varying the ratio of oxygen-depleted air to air of greater oxygen content in said input air mix, said voltage monitoring means being configured to instruct the varying means to vary the ratio of said air mix with the aim of optimising said output voltage.

27. A fuel cell system comprising a fuel cell stack, apparatus for mixing to a variable extent oxygen-depleted air output from the stack with air having a greater oxygen content to provide an air mix for input as fuel to the stack, and apparatus for supplying said air mix to the stack.

28. A system according to claim 27, further comprising a device for detecting the humidity of said air mix.

29. A system according to claim 28, wherein said mixing apparatus automatically varies the ratio of oxygen-depleted air to air of greater oxygen content in said air mix in accordance with the humidity detected by said humidity detecting device.

30. A system according to claim 27, further comprising a device that monitors the voltage output of the fuel cell stack.

31. A system according to claim 30, wherein said mixing apparatus automatically varies the ratio of oxygen-depleted air to air of greater oxygen content in said air mix in accordance with said voltage output.

32. A fuel cell system comprising:
a fuel cell stack having an inlet for receiving fuel air and an exhaust outlet for exhaust air;
an air mixer having a first inlet connected with said exhaust outlet, a second inlet for receiving a relatively oxygen-rich air supply and an outlet connected with said fuel cell stack inlet for the supply of said fuel air from said air mixer; and
a controller which monitors at least one operating parameter of the fuel system and causes said air mixer to vary a ratio of exhaust air and relatively oxygen rich air in said fuel air in accordance with said at least one operating parameter.

33. A system according to claim 32, wherein said at least one operating parameter is voltage output of the system, and said controller is connected with a voltage detecting device for detecting said voltage output.

34. A system according to claim 32 or 33, wherein said at least one operating parameter is humidity of said fuel air and said controller is connected with a device for sensing humidity of said fuel air.

35. A fuel cell system comprising a fuel cell stack, apparatus for extracting water from a stream of relatively water-rich oxygen-depleted air output from the stack, and means for facilitating the evaporation of said extracted water.

36. A system according to claim 35, wherein the facilitating means is operable to route said extracted water to one or more relatively hot components of the system.

37. A system according to claim 35, wherein the facilitating means is operable to route said extracted water to one or more fans.

38. A system according to claim 36 and 37, wherein the facilitating means is operable to route said extracted water to one or more relatively hot components of the system and to one or more fans.

39. A fuel cell system comprising a fuel cell stack, means for extracting water from a stream of relatively water-rich oxygen-depleted air output from the stack, and means for facilitating the evaporation of said extracted water.

40. A system according to claim 39, wherein the facilitating means is operable to route said extracted water to one or more relatively hot components of the system.

41. A system according to claim 39, wherein the facilitating means is operable to route said extracted water to one or more fans.

42. A system according to claim 39 and 40, wherein the facilitating means is operable to route said extracted water to one or more relatively hot components of the system and to one or more fans.

43. A fuel cell system comprising a fuel cell stack, a device connected with said stack for receiving exhaust air from said stack and extracting water from said exhaust air and a member connected with said device for receiving said extracted water and facilitating evaporation of the received water.

44. A system according to claim 43, wherein said member comprises a conduit for conducting said received water to a location adjacent said stack for facilitating evaporation by heat from said stack.

45. A system according to claim 44, wherein said conduit contains a wicking material.

46. A system according to claim 43, wherein said member comprises a conduit arranged to conduct said received water to a location at which it is exposed to an air flow from at least one fan.

47. A system according to claim 46, wherein said conduit contains a wicking material.

48. A fuel cell system comprising:
a fuel stack;
a hydride fuel supply canister connected with said fuel stack and arranged such that, in use, it receives heat from said fuel stack, said hydride fuel canister being provided with a data storage element for storing data concerning the canister;
a data reader for reading data stored on said storage element; and
a controller connected with said data reader, and operable to determine power output by said fuel system, said controller being operable to determine an indication of the amount of fuel contained in said canister based on data read from said storage element and said power output.

49. A fuel cell system comprising:
a fuel stack having an inlet for receiving fuel air and an exhaust outlet for exhaust air;
a hydride fuel supply canister connected with said fuel stack and arranged such that, in use, it receives heat from said fuel stack, said hydride fuel canister being provided with a data storage element for storing data concerning the canister;
a data reader for reading data stored on said storage element;
a controller connected with said data reader, and operable to determine power output by said fuel system, said controller being operable to determine an indication of the amount of fuel contained in said canister based on data read from said storage element and said power output; and
an air mixer having a first inlet connected with said exhaust outlet, a second inlet for receiving a relatively oxygen-rich air supply and an outlet connected with said fuel cell stack inlet for supplying said fuel air from said air mixer, wherein said controller monitors at least one operating parameter of the fuel system and causes said air mixer to vary a ratio of exhaust air and relatively oxygen rich air in said fuel air in accordance with said at least one operating parameter.

50. A fuel system comprising:
a fuel stack having an inlet for receiving fuel air and an exhaust outlet for exhaust air;
a hydride fuel supply canister connected with said fuel stack and arranged such that, in use, it receives heat from said fuel stack, said hydride fuel canister being provided with a data storage element for storing data concerning the canister;
a read/write device for reading data stored on said storage element and writing new data to said storage element;
a controller connected with said read/write device and operable to determine power output by said fuel system, said controller being operable to determine an indication of the amount of fuel contained in said canister based on data read from said storage element by said read/write device and said power output and to write new data to said storage element based on said indication of the amount of fuel contained in said canister; and
an air mixer having a first inlet connected with said exhaust outlet, a second inlet for receiving a relatively oxygen-rich air supply and an outlet connected with said fuel cell stack inlet for supplying said fuel air from said air mixer, wherein said controller monitors at least one operating parameter of the fuel system and causes said air mixer to vary a ratio of exhaust air and relatively oxygen rich air in said fuel air in accordance with said at least one operating parameter.

51. A fuel system comprising:
a fuel stack having an inlet for receiving fuel air and an exhaust outlet for exhaust air;
a hydride fuel supply canister connected with said fuel stack and arranged such that, in use, it receives heat from said fuel stack, said hydride fuel canister being provided with a data storage element for storing data concerning the canister;
a read/write device for reading data stored on said storage element and writing new data to said storage element;
a controller connected with said read/write device and operable to determine power output by said fuel system, said controller being operable to determine an indication of the amount of fuel contained in said canister based on data read from said storage element by said read/write device and said power output and to write new data to said storage element based on said indication of the amount of fuel contained in said canister;
an air mixer having a first inlet connected with said exhaust outlet, a second inlet for receiving a relatively oxygen-rich air supply and an outlet connected with said fuel cell stack inlet for supplying said fuel air from said air mixer, wherein said controller monitors at least one operating parameter of the fuel system and causes said air mixer to vary a ratio of exhaust air and relatively oxygen rich air in said fuel air in accordance with said at least one operating parameter; and
a humidity detector for detecting the humidity of said fuel air and connected with said controller, wherein said at least one operating parameter includes humidity of said fuel air.
